(19) United States
(12) Patent Application Publication
(10) Pub. No.: US 2009/0174571 A1
(43) Pub. Date: Jul. 9, 2009

(54) Navigation apparatus having emergency warning system

(76) Inventor: Louis H. McKenna, Roseville, MN (US)

Correspondence Address: ROBERT J JACOBSON PA, 650 BRIMHALL STREET SOUTH, ST PAUL, MN, 551161511, US

(21) Appl. No.: 12/008,061

(22) Filed: Jan. 7, 2008

(51) Int. Cl. G08G 1/00

(52) U.S. Cl. 340/901

(57) ABSTRACT

A navigation system having an emergency warning system where the navigation system includes components such as a navigation processor, a GPS, a speaker for providing text-to-voice directions, a display for displaying at least the starting location and final destination, power switch, and a power port that permits connection to the cigarette lighter port of the vehicle, and wherein the emergency warning system includes a component such as a receiver for picking up a right of way vehicle predefined signal. When the right of way vehicle predefined signal is picked up, the emergency warning system can display various warnings such as a text warning or an audible warning via the display and speaker.

### FIELD OF THE INVENTION

The present invention generally relates to navigation apparatus, particularly to navigation apparatus for use in vehicles, and specifically to navigation apparatus that include emergency warning systems for notifying the driver of the vehicle of the approach of a right of way vehicle.

### BACKGROUND OF THE INVENTION

A navigation apparatus is in part a “real time” apparatus. In other words, one feature of a navigation apparatus is a GPS device. The driver of a vehicle having a navigation apparatus taps the capabilities of satellites to, for example, determine his or her position at a certain point in time.

A navigation apparatus is in part removed from “real time.” In other words, one feature of a navigation apparatus is a data base having information on highway layout. However, highways are closed. Detours are instituted. Unless a driver of the vehicle updates the database of his or her navigation apparatus on a daily basis, and unless the company maintaining the database is vigilant on a daily basis with a great plurality of departments of transportation, the driver consulting a navigation apparatus may encounter as many detours as a driver having no navigation apparatus to consult.

### SUMMARY OF THE INVENTION

A feature of the present invention is the provision in a navigation apparatus, of an emergency warning system.

Another feature of the present invention is the provision in a navigation apparatus, of a navigation apparatus having a processor, a global positioning system, a power switch, a display, a speaker, and a power port, and of the navigation apparatus further having an emergency warning system.

Another feature of the present invention is the provision in a navigation apparatus, of an emergency warning system, wherein the emergency warning system includes a receiver for picking up a right of way vehicle predefined signal, and with the emergency warning system emitting, when the right of way predefined signal has been picked up, at least one of an audio warning via the speaker and a visible warning via the display.

Another feature of the present invention is the provision in a navigation apparatus, of a navigation apparatus having a processor, a global positioning system, a power switch, a display, a speaker, a power port, and an emergency warning system, wherein the emergency warning system includes a receiver for picking up a right of way vehicle predefined signal, and with the emergency warning system emitting, when the right of way predefined signal has been picked up, at least one of an audio warning via the speaker and a visible warning via the display.

Another feature of the present invention is the provision in a navigation apparatus, of the navigation having a housing that includes an accessible portion accessible for picking up said right of way vehicle predefined signal, and wherein a receiver for picking up the right of way predefined signal is engaged with the accessible portion of the housing.

Another feature of the present invention is the provision in a navigation apparatus, of the navigation apparatus having a receiver that is responsive to light, wherein the light responsive receiver picks up a right of way predefined signal.

Another feature of the present invention is the provision in a navigation apparatus, of the navigation apparatus having a photocell that is responsive to light, wherein the light responsive photocell picks up a right of way predefined signal.

An advantage of the present invention is that it improves the real time capabilities of a navigation apparatus.

Another advantage of the present invention is the incorporation of an emergency warning system into a device that may soon be commonly carried in vehicles. Since the device may soon be commonly carried in vehicles, chances are increased that a driver in the vehicle will be responsive to warnings emitted by the device, and hence chances are increased that right of way vehicles will move more readily through traffic. This device is a navigation apparatus.

Another advantage of the present invention is the incorporation of an emergency warning system into a device that relates to driving. Since the device relates to driving, chances are increased that a driver will be responsive to warnings emitted by the device, and hence chances are increased that right of way vehicles will move more readily through traffic. This device is a navigation apparatus.

Another advantage of the present invention is that features of a navigation apparatus may be utilized for features of the present emergency warning system. For example, a navigation apparatus may have a text-to-voice feature that may utilize a speaker, and the text-to-voice feature and/or speaker may be utilized for emitting warnings of the approach of a right of way vehicle, including warnings of the direction of the approach of the right of way vehicle. These audio warnings can include the sound of an animated siren as well as a voice saying “be careful—right of way vehicle in area.” Another example is the display of the navigation apparatus. This display, such as a touch screen display, can show a text warning, such as a flashing of the phrase “EMERGENCY VEHICLE. This display, depending upon the number and type of receivers utilized, may show a road map with a flashing star that represents the general location of a right of way vehicle, or may dynamically represent the location (and thus changing location) of the right of way vehicle.

### BRIEF DESCRIPTION OF THE DRAWINGS

FIG. 1A is a perspective, partially diagrammatic, front view of the present navigation apparatus having an emergency warning system.

FIG. 1B is a perspective, partially diagrammatic, rear view of the navigation apparatus of FIG. 1A.

FIG. 2 is a perspective view of a mount for the navigation apparatus of FIG. 1A.

FIG. 3 is a diagrammatic illustration of the emergency warning system of the navigation apparatus of FIG. 1A.

### DETAILED DESCRIPTION

The Navigation System of the Navigation Apparatus 10

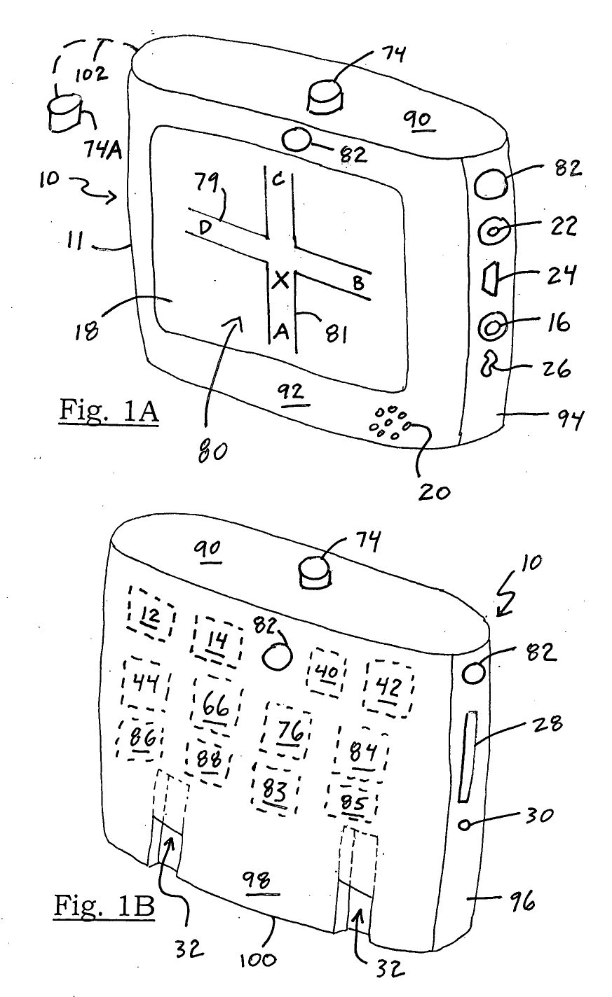

The navigation apparatus of the present invention is indicated in general by reference number 10 in FIGS. 1A and 1B. Navigation apparatus 10 includes a housing 11, one or more processors 12 in the housing 11, a global positioning system or position sensor 14 in the housing 11, a power switch or on/off switch 16 on a right side of the housing 11, a touch screen display 18 on the front face of the housing 11, a speaker 20 in the housing 11 and emitting sound from the front face of the housing 11, a power port 22 on the right side of the housing 11 where the power port 22 may communicate with an extension or adapter that plugs into the cigarette lighter socket of a vehicle, and a computer port 24 on the right side of the housing 11 where the computer port may be a USB port for downloading information. Navigation apparatus 10 further includes a port 26 for earphones or head phones or in-ear head phones on the right side of the housing 11, a port 28 for a memory card on the left side of the housing 11, and a reset button 30 for rebooting the navigation apparatus 10 upon operation freeze-up. Navigation apparatus 10 further includes a pair of receptacles 32 for receiving a pair of arms 34 of a mount 36 that mounts the navigation apparatus 10 within the interior of a vehicle such as to a windshield via a suction cup 38.

Navigation system 10 can include a control unit for entering the starting location, any intermediate destinations, and the final destination, and this control unit 10 can include or be accessed by the touch screen display 18, a data medium 40 in the housing 11 for storing navigational data such as information to display road maps), a navigation computer, such as processor 12, to plan or compute the route and provide guidance to the destination, a data processing unit 42 in the housing 11 to process the route data into picture information, and a display, such as the touch screen display 18 to display road maps, position information, destination information, and other types of information. The navigation system 10 can also include a plurality of sensors to determine the vehicle's position, speed, and orientation, and provide that information to the navigation computer 12. One such sensor can be the GPS sensor 14. Individual components of the navigation apparatus 10 can communicate over a data bus 44 in the housing 11. The data processing unit 42 often includes a picture memory that stores picture information.

The navigation apparatus 10 can receive data input. Data input can be received from the computer port or USB port 24 such that data can be downloaded from computer connected to the Internet, such as from the server of a company selling road map information or traffic information. Data input can be received from a memory card via the memory card port 28. Thus the navigation apparatus 10 can retrieve map information such as road map information.

As to navigation apparatus 10, the following U.S. patent are hereby incorporated by reference in their entireties: a) the Laverick et al. U.S. Pat. No. 7,313,477 B1 issued Dec. 25, 2007 and entitled Vehicle Dash-Mounted Navigation Device; b) the Hatch et al. U.S. Pat. No. 7,212,155 B2 issued May 1, 2007 and entitled GPS Navigation Using Successive Differences Of Carrier-Phase Measurements; c) the Bahren et al. U.S. Pat. No. 7,162,364 B2 issued Jan. 9, 2007 and entitled Motor Vehicle Navigation System; d) the Burch et al. U.S. Pat. No. 7,054,725 B2 issued May 30, 2006 and entitled GPS Navigation Device; and e) the Agnew et al. U.S. Pat. No. 6,950,745 B2 issued Sep. 27, 2005 and entitled Navigation System.

A Mount for the Navigation Apparatus 10

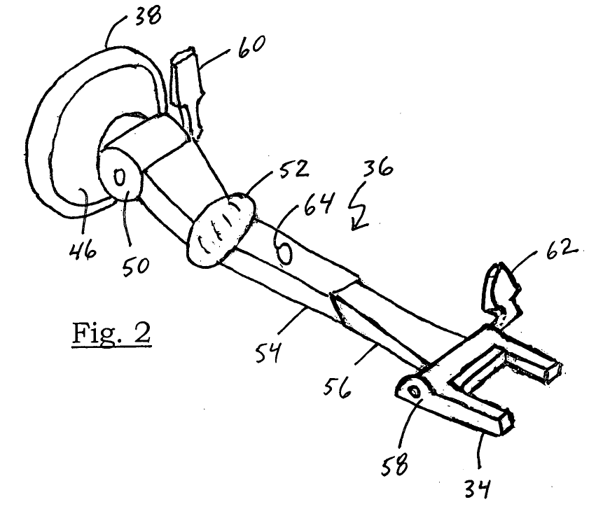

The mount 36 for the navigation apparatus 10 is shown in FIG. 2. As indicated above, mount 36 includes, at one end, the suction cup 38 for engaging a surface such as a windshield. At the other end, the mount 36 includes the pair of arms 34 for engaging the receptacles 32 formed in the rear face of the housing 11 of the navigation apparatus 10.

Mount 36 further includes a base 46 for the suction cup 38 and a train mechanism 48 for extending from the base 46 to the pair of arms 34. The train mechanism 48 includes a first axis mechanism 50 for relating the navigation apparatus 10 about a first linear axis, a ball joint 52 for articulation of the navigation apparatus 10 generally about the surface of a sphere for at least about 50% of the surface portion of the sphere, a first telescoping portion 54 receiving a second telescoping portion 56 for increasing and decreasing a distance from the suction cup 38 to the navigation apparatus 10, and a second axis mechanism 58 for relating the navigation apparatus 10 about a second linear axis. First axis mechanism 50 includes a locking lever 60 that fixes the axis mechanism 50 such that no pivoting can occur therein, and second axis mechanism 58 includes a locking lever 62 that fixes axis mechanism 58 such that no pivoting can occur therein. First and second telescoping portion 54 includes a button 64 to release portions 54, 56 relative to each other. Button 64 is normally in a locked position (when not depressed). When depressed, button 64 releases telescoping portion 56, which is drawn into telescoping portion 54, such that telescoping portion 54 is normally biased inwardly. Via a ratchet mechanism or some other mechanism, telescoping portion 56 can be drawn outwardly of telescoping portion 56 at any time, even when button 64 is not depressed.

The Emergency Warning System of the Navigation Apparatus 10

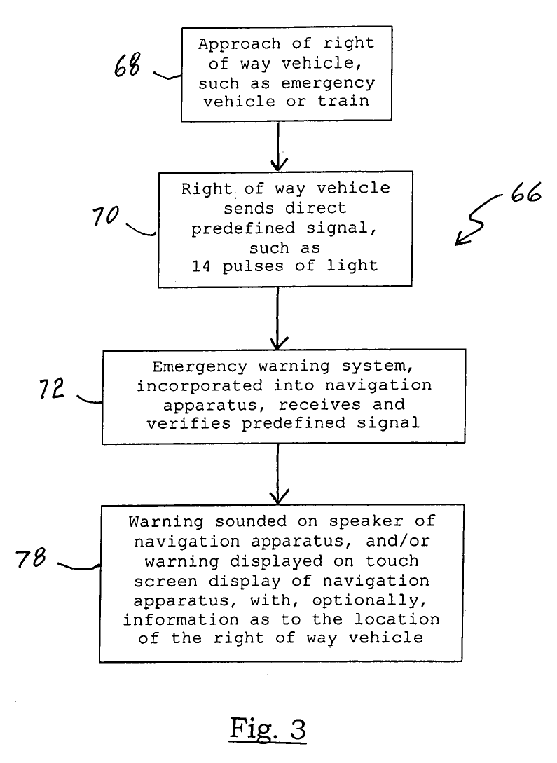

The present emergency warning system is indicated in general by the reference number 66 in FIG. 1B and FIG. 3. The emergency warning system 66 can be housed, in electronic form such as in the processor 12, in the housing 11 of the navigation apparatus 10.

The general operation of the emergency warning system 66 is illustrated in FIG. 3. Step 68 indicates the approach of a right of way vehicle. The right of way vehicle may be a police car, an ambulance, a fire engine, a train, or another vehicle traveling a relatively high speeds for the area in which it is traveling, such as an urban area or a rural area or another type of area.

The right of way vehicle can be sending a direct predefined signal to, for example, control lights at intersections or turn all of the lights at an intersection to the red color and this step of sending the predefined signal is indicated by step 70 in FIG. 3. One type of direct signal is a cone type of radio frequency (RF) signal. Such a cone signal may cover a relatively broad area or a relatively narrow area, depending upon the type of traffic situation or type of roadway that a right of way vehicle will encounter. Preferably the cone of the cone signal is relatively narrow so as to generate warnings in only those objects that are found in potentially blocking vehicles in the pathway of the right of way vehicle. A direct signal is not necessarily a cone signal. A direct signal can be a signal that travels directly from the right of way vehicle to the potentially blocking vehicle without any aid from an outside or third party infrastructure such as a cell phone network. The direct signal can be one or more of 1) a strobe light signal, 2) a radio signal such as a digital radio signal, 3) a dedicated short-range communication signal, and 4) a wireless local area network signal. Any of such direct signals can carry information that is utilized by the emergency warning system 66, with such information being, for example, the presence of an emergency warning vehicle and the type of emergency warning vehicle.

As further shown in FIG. 3, emergency warning method or system 66 includes a step 72 of receiving and verifying the direct predefined signal. The step of receiving the signal can be performed by a receiver 74. Receiver 74 is a photoreceptor mounted on the top of housing 11. Receiver 74 is generally cylindrical in shape with an endless sidewall and a flat top. Receiver 74 is electrically in communication with the circuitry of the navigation apparatus 10, including the processor 12. Preferably, the receiver 74 of the emergency warning system 10 is always on. Receiver 74 can be powered by a stand alone single purpose dedicated battery 76 housed in the housing 11, where the single purpose of battery 76 is to provide power to the hardware of the emergency warning system 66, including the speaker 20 and the touch screen display 18. The step 72 of verifying verifies that the right of way predefined signal is from an authorized right of way vehicle. The step of verifying can include: 1) counting pulses, such as 14 pulses, where the signal is a direct light signal, 2) matching the signal with stored information where the signal is digital radio signal, a dedicated short-range communication signal, or a wireless local area network signal, or 3) some other method where only authorized transmissions can be verified.

As shown in FIG. 3, emergency warning method or system 66 includes a step 78 of generating a warning. Preferably the step 78 of generating a warning includes the step of sounding a warning on a speaker 20. Step 78 may include the step of displaying a warning such as on a touch screen display 18.

Step 78 of generating a warning can also include the step of sounding or displaying information carried by the right of way predefined signal. Such information to be sounded or displayed can include information on one or more of the proximity of the right of way vehicle, the type of right of way vehicle, and the speed of the right of way vehicle. Examples of warnings are voice warnings, animated siren warnings, and blinking red lights.

Photoreceptor 74 can, if desired, be physically and thus electronically separated into four equal portions, where each portion is a pie fashioned portion and extends for exactly 90 degrees about the cylindrical shape of the photoreceptor as a whole. In other words, one photoreceptor portion can extend from southwest direction, through the south direction, to the southeast direction. A second photoreceptor portion can extend from the southeast direction, through the east direction, to the northeast direction. A third photoreceptor portion can extend from the northeast direction, through the north direction, to the northwest direction. A fourth photoreceptor portion can extend from the northwest direction, through the west direction, to the southwest direction. Each of the portions can communicate physically separately and thus electronically separately from each of the other portions with the processor 12 and emergency warning system 66. Thus, the emergency warning system 66 can display a map 80, where number 79 represents a first road, where number 81 represents a second road, where the character X marks the vehicle having the navigation apparatus 10, where the character A marks the location of a first right of way vehicle sending a light signal that is picked up by the first photoreceptor portion, where the character B marks the location of a second right of way vehicle sending a light signal that is picked up by the second photoreceptor portion, where the character C marks the location of a third right of way vehicle sending a light signal that is picked up by the third photoreceptor portion, where the character D marks the location of a fourth right of way vehicle sending a light signal that is picked up by the fourth photoreceptor portion.

Direct Right of Way Predefined Signal

A direct right of way predefined signal is a signal such as a light signal or strobe light signal. As to generating, receiving and utilizing a strobe light signal or other types of signals, the following U.S. patents are hereby incorporated by reference in their entireties: 1) the McKenna U.S. Pat. No. 5,495,243 issued Feb. 27, 1996 and entitled Emergency Vehicle Alarm System For Vehicles, 2) the Henry et al. U.S. Pat. No. 6,094,148 issued Jul. 25, 2000 and entitled Vehicular Emergency Vehicle Alarm Apparatus, 3) the McKenna U.S. Pat. No. 6,252,519 B1 issued Jun. 26, 2001 and entitled Emergency Vehicle Signaling System, 4) the Hamer U.S. Pat. No. 5,187,476 issued Feb. 16, 1993 and entitled Optical Traffic Preemption Detector Circuitry, 5) the Hamer et al. U.S. Pat. No. 5,202,683 issued Apr. 13, 1993 and entitled Optical Traffic Preemption Detector, and 6) the Haagenstad et al. U.S. Pat. No. 5,602,739 issued Feb. 11, 1997 and entitled Vehicle Tracking System Incorporating Traffic Signal Preemption.

The receiver, such as photosensitive or photo cell 74 is displayed prominently and clear of obstructions for a clean path for detection of a strobe light generated from behind the vehicle having the navigation apparatus 10 or generated from the front, right side, left side, or any other direction relative to the vehicle having the navigation apparatus 10. The photosensitive cell 74 can be in a cylindrical or spherical or hemispherical form such that the photosensitive cell 74 picks up a strobe light regardless of the orientation of the navigation apparatus 10. If desired, one or more photosensitive cells 82 can be located on one or more of the front face, rear face, right side, and left side of the navigation apparatus 10, as shown in FIGS. 1A and 1B. These stand alone or extra photosensitive cells or photocells 82 can provide further information as to the direction that the right of way predefined signal is coming from in the same manner as the first, second, third and fourth photoreceptor portions of photoreceptor 74 provide such information.

In other words, one or more of the photosensitive cells 74 and 82 can be engaged to a top side 90, front face 92, right side 94, left side 96, back face 98 and bottom side 100 of the housing 11 of the navigation apparatus 10. One of more of the photosensitive cells 74 and 82 can project from a plane of the surface of the housing 11 in which it is set. One or more of the photosensitive cells 74 and 82 need not project from a plane of the surface of the housing 11 in which it is set; an outermost portion of the photosensitive cell 74 or 82 may be in the plane of the surface of the housing in which it is set or may be inset in the housing 11 such that an outermost portion of the photosensitive cell 74 or 83 may be inwardly of the plane of the surface of the housing 11 in which it is set.

In still other words, an array or set of photosensitive cells 74 and 82 may be arranged about the housing 11 of the navigation apparatus 10 such that the emergency warning system 66 of the navigation apparatus 10 is responsive to a signal emanating from a direction forwardly of said navigation apparatus 10, rearwardly of said navigation apparatus 10, rightwardly of said navigation apparatus 10, or leftwardly of said navigation apparatus 10, or from a direction between said rearwardly, frontwardly, rightwardly and leftwardly directions such that the emergency warning system 66 is responsive to signals emanating from any direction in a generally horizontal 360 degree arc or circle about the navigation apparatus 10.

It should be noted that one embodiment for the navigation apparatus 10 includes four receivers, where the four receivers may be one or more of the receivers 74 and 82, and where the receivers can be enumerated as first, second, third and fourth receivers, and where the first, second, third and fourth receivers can be respectively disposed on the front face or side 92, rear face or side 98, right side 94, and left side 96 of the housing 11 of the navigation apparatus 10.

It should be noted that separate receivers or photocells 74 or 82 may be preferred. However, if desired, there may be available bands of photosensitive material that can extend around the navigation apparatus 10 in the horizontal and or vertical directions.

It should be noted that, with direct right of way predefined signals, such as with a light signal, a relatively powerful light signal element is first sent. This relatively powerful light signal element is sent as a trigger to, in effect, switch on the emergency warning system or switch on the photocell 74. This relatively powerful light signal element that is required to switch on the photocell 74 eliminates transient light. After reception of the relatively powerful light signal element, then the main signal element is sent, such as 14 pulses or 14 blinks of light. This 14 pulses or blinks of light then sets into motion or operation the emergency warning system 66.

Since the navigation apparatus 10 includes the GPS device 14, the navigation apparatus 10 may dynamically adjust to the angle or position of the navigation apparatus 10. For example, the mount 36 may hold the navigation apparatus 10 at an angle relative to the direction the vehicle is being driven. Thus, the rear face 98 of the navigation apparatus 10 may not relate directly to the forwardly direction. Likewise, the front face 92 of the navigation apparatus 10 may not relate directly to the rearwardly direction. However, the GPS device 14 or other position sensors can take into account the absolute position of the GPS device 14 itself and thus the absolute position of the navigation apparatus 10, and thus can adjust this position and the position or positions of the receivers 74 and 82 relative to the direction that the vehicle is being driven. Accordingly, even if the navigation apparatus 10 is being held at, for example, a 45 degree angle relative to the line on which the vehicle is being driven, the display 80 can represent at least the general location of the source of the predefined right of way signal.

Another direct right of way predefined signal is a signal such as a radio frequency signal. As to an emergency warning system, including the steps of transmitting and receiving a radio frequency signal, the following U.S. patents are hereby incorporated by reference in their entireties: 1) the McKenna U.S. Pat. No. 6,252,519 issued Jun. 26, 2001 and entitled Emergency Vehicle Signaling System, and 2) the Hall et al. U.S. Pat. No. 5,539,398 issued Jul. 23, 1996 and entitled GPS-Based Traffic Control Preemption System. The radio frequency signal may be generated and received at or about at least one of 2.4 and 5.9 GHz. A radio receiver 84 can be housed in housing 11 and tied into the emergency warning system 66 and processor 12.

Another direct right of way predefined signal is a dedicated (or directed) short-range communication (DSRC) signal generated by a DSRC apparatus and received by a DSRC apparatus incorporated into the emergency warning system 66. As to a DSRC apparatus or system, the Inoue U.S. Pat. No. 6,300,882 B1 issued Oct. 9, 2001 and entitled Vehicle-Onboard DSRC Apparatus is hereby incorporated by reference in its entirety. The DSRC signal may be generated and received at or about at least one of 2.4 and 5.9 GHz. A DSRC receiver 83 can be housed in housing 11 and tied into the emergency warning system 66 and processor 12.

Another direct right of way predefined signal is a wireless local area network signal generated by a wireless local area network apparatus and received by a wireless local area network apparatus incorporated into the emergency warning system 66. As to a wireless local area network apparatus or system, the Budin et al. U.S. Pat. No. 5,276,703 issued Jan. 4, 1994 and entitled Wireless Local Area Network Communications System is hereby incorporated by reference in its entirety. The wireless local area network signal may be generated and received at or about at least one of 2.4 and 5.9 GHz. One local area network system is the IEEE 802.11 (or IEEE 802.11A) system where IEEE stands for Institute of Electrical and Electronics Engineers. Another local area network system is Motorola's control channel based Freespace system. The wireless local area network signal may be generated and received at or about at least one of 2.4 and 5.9 GHz. A wireless local area network receiver 85 can be housed in housing 11 and tied into the emergency warning system 66 and processor 12.

Another direct right of way predefined signal is a digital radio signal generated by a digital radio apparatus and received by a digital radio apparatus incorporated into the emergency warning system 66. As to a digital radio apparatus or system, the Davis et al. U.S. Pat. No. 6,804,525 B2 issued Oct. 12, 2004 and entitled Method And Apparatus For Facilitating Two-Way Communications Between Vehicles is hereby incorporated by reference in its entirety. The digital radio signal may be generated and received at or about at least one of 2.4 and 5.9 GHz. The radio receiver 84 may receive digital signals.

Another direct right of way predefined signal is an infrared signal, such as one centered at about 0.950 micrometers and modulated with a 40 KHz carrier. Such an infrared signal can be received by an infrared receiver that includes a photovoltaic detector in parallel with a tunable inductor. As to such, the Smith U.S. Pat. No. 4,704,610 issued Nov. 3, 1987 and entitled Emergency Vehicle Warning And Traffic Control System is hereby incorporated by reference in its entirety. Such a photovoltaic detector can be mounted on the housing 11 of the navigation apparatus 10.

Power Always On

Preferably, the emergency warning system or method 66 includes the step of providing the dedicated battery 76 such that the emergency warning system or method 66 is always on. If desired, the emergency warning system or method 66 can draw power from a battery 86 in housing 11 or from the navigation apparatus 10 via the power port 22.

With or without the dedicated battery 76, the emergency warning system 66 can be in an always on state, such as by drawing an extremely minimal amount of current from the battery 86 or from the vehicle via the power port 22 and cigarette lighter socket.

A Tamper Proof Emergency Warning System 66

Numerous methods exist for making the emergency warning system 66 tamper proof as, for example: 1) the dedicated battery 76 can be provided in the housing 11 such that it is moot whether or not the primary power source 86 or power port 22 for the navigation apparatus 10 is providing power to the emergency warning system 66; 2) the dedicated battery 76 in the housing 11 can be disguised such that the man on the street cannot find such dedicated battery 76; 3) the dedicated battery 76 in the housing 11 can be so tiny that is difficult to locate; and/or 4) the emergency warning system 66 itself, including the dedicated battery 76, can be molded into the housing 11 such that only by destroying the navigation apparatus 10 can the emergency warning system 66 be disabled.

The Step of Providing Feedback from the Potentially Blocking Vehicle to the Right of Way Vehicle

The emergency warning system or method 66 can include the step of providing feedback from the potentially blocking vehicle to the right of way vehicle. This step of providing feedback can include the step of providing a dedicated transmitter 88 in the housing 11 and tying such to the emergency warning method or system 66. Such a feedback signal can be an automatic feedback signal where the driver or passenger of the potentially blocking vehicle performs no act and the emergency warning system or method 66 generates the feedback signal automatically. As to an automatic feedback signal, the following U.S. patents are hereby incorporated by reference in their entireties: a) the McKenna U.S. Pat. No. 5,495,243 issued Feb. 27, 1996 and entitled Emergency Vehicle Alarm System For Vehicles, and b) the McKenna U.S. Pat. No. 6,252,519 issued Jun. 26, 2001 and entitled Emergency Vehicle Signaling System.

Stand Alone Photocell for the Stand Alone Navigation Apparatus 10 and for OEM Navigation Apparatus

The navigation system and emergency warning system of the present navigation apparatus 10 is preferably in a housing 11 such that the navigation apparatus 10 is a stand alone navigation apparatus 10. The stand alone navigation apparatus 10 may utilize a mount, such as mount 36, for securing and positioning the navigation apparatus 10 within a vehicle at a location desired by the driver of the vehicle. Such a mount may or may not bring the stand alone navigation apparatus into a “line of sight” where the predefined signal such as a light signal is picked up. If desired, a stand alone photocell 74A, shown in FIG. 1A, may be utilized, with an electrical connection 102 extending between the navigation apparatus 10 and the stand alone photocell 74A. The stand alone photocell 74A can be affixed at a “line of sight” location in the vehicle or at a “line of sight” location on the exterior of the vehicle. And, if desired, there may be more than one stand alone photocells 74A. For example, by positioning photocells 74A on different sides or ends of the vehicle, the direction that the right of way vehicle is coming from may be determined because only one or several photocells 74A may pick up the direct predefined light signal to the exclusion of the other photocells 74A.

The navigation system and emergency warning system of the present invention may be OEM systems that are built in to the information panels or dashboards of vehicles and that are OEM systems that come with the vehicle when the vehicle is sold as a new vehicle. Where the navigation apparatus of the present invention includes OEM navigation and emergency warning systems, there may or may not be a “line of sight” from the information panel that extends rearwardly out of the vehicle such that, when a right of way vehicle is emitting the direct predefined signal such as a light signal or strobe light signal, the photocell 74 or 82 may not pick up the direct predefined signal. In such a case, the photocell 74 or 82 may be the stand alone photocell 74A as shown in FIG. 1A. An electrical connection can extend between the photocell 74A and the OEM navigation apparatus. The stand alone photocell for the OEM navigation apparatus can be affixed at a “line of sight” location in the vehicle or at a “line of sight” location on the exterior of the vehicle, and, as indicated above, there may be several stand alone photocells 74A in communication with the OEM navigation apparatus.

Operation

As a right of way vehicle, such as an ambulance or train, is making its way down the road or along the tracks, the right of way vehicle issues the direct predefined signal. The signal can carry information such as the type of right of way vehicle, the proximity of the right of way vehicle relative to the potentially blocking vehicle, the speed of the right of way vehicle 18, as well as other information. The navigation apparatus 10 housing the emergency warning system or method 66, verifies the signal has originated from an authentic source, and generates a warning. The warning may be an audio warning on speaker 20. If desired, the warning can be a visual warning on touch screen display 18 or each of an audio and visual warning at the same time. It is then hoped that the driver of the potentially blocking vehicle steers out of the way and stops.

The McKenna U.S. Patent Application Publication Number US-2006-0255966-A1 published on Nov. 16, 2006 and entitled Emergency Warning System For Approach Of Right Of Way Vehicle is hereby incorporated by reference in its entirety into this application.

The McKenna U.S. patent application Ser. No. 11/504,867 filed Aug. 16, 2006 and entitled Emergency Warning System For Approach Of Right Of Way Vehicle is hereby incorporated by reference in its entirety into this application.

It should be noted that a great many intersections in the United States of America and Canada utilize the Opticom Priority Control System, a type of control system that provides intersection right-of-way to authorized vehicles. It is believed that this system is related to the technology found in the following U.S. patents, which are incorporated by reference in their entireties into this application: 1) the Hamer U.S. Pat. No. 5,172,113 issued Dec. 15, 1992 and entitled System And Method For Transmitting Data In An Optical Traffic Preemption System; 2) the Hamer U.S. Pat. No. 5,187,476 issued Feb. 16, 1993 and entitled Optical Traffic Preemption Detector Circuitry; 3) the Hamer U.S. Pat. No. 5,187,476 issued Feb. 16, 1993 and entitled Optical Traffic Preemption Detector Circuitry, 4) the Hamer et al. U.S. Pat. No. 5,202,683 issued Apr. 13, 1993 and entitled Optical Traffic Preemption Detector, and 5) the Haagenstad et al. U.S. Pat. No. 5,602,739 issued Feb. 11, 1997 and entitled Vehicle Tracking System Incorporating Traffic Signal Preemption. This technology, or particularly the type of signals that are emitted by right-of-way vehicles, that include a set of 14 pulses of light, can be put to great advantageous use when used in association with navigation apparatus. This technology is already part of a traffic system widely employed, but this technology has been overlooked by companies manufacturing navigation apparatus. This technology, or set of 14 pulses of light, is being emitted freely. There is no added expense to the traffic infrastructure. There is no added expense to the department of transportation of the many states.

I claim:

1. A navigation apparatus comprising:
a) a navigation system, wherein said navigation system includes a processor, a global positioning system, a display, and a speaker; and
b) an emergency warning system for picking up a right of way vehicle predefined signal, with the emergency warning system being in communication with said navigation system, with the emergency warning system comprising a first receiver responsive to said right of way vehicle predefined signal, and with the emergency warning system emitting, when said right of way vehicle predefined signal has been picked up by said first receiver, at least one of an audio warning via said speaker and a visible warning via said display.

2. The navigation apparatus of claim 1, and further comprising a housing having said navigation system and emergency warning system such that said navigation apparatus is a stand alone navigation apparatus.

3. The navigation apparatus of claim 2, wherein said first receiver is engaged with said housing.

4. The navigation apparatus of claim 1, wherein said first receiver is responsive to light.

5. The navigation apparatus of claim 1, wherein said first receiver comprises a photocell responsive to light.

6. The navigation apparatus of claim 2, wherein said first receiver projects from the housing of the navigation apparatus.

7. The navigation apparatus of claim 2, wherein said first receiver is disposed on at least one of a top side, front side, rear side, right side, left side, and bottom side of the navigation apparatus.

8. The navigation apparatus of claim 2, and further comprising second, third and fourth receivers, wherein said first, second, third and fourth receivers are respectively disposed on a front side, rear side, right side, and left side of the housing of the navigation apparatus.

9. The navigation apparatus according to claim 2, wherein said first receiver stands alone apart from the housing of the navigation apparatus.

10. The navigation apparatus according to claim 1, wherein said first receiver stands alone apart from the navigation apparatus.

11. The navigation apparatus according to claim 1, wherein said first receiver is responsive to a signal emanating from a direction forwardly of said navigation apparatus, rearwardly of said navigation apparatus, rightwardly of said navigation apparatus, or leftwardly of said navigation apparatus, or from a direction between said rearwardly, frontwardly, rightwardly and leftwardly directions.

12. The navigation apparatus according to claim 1, wherein said emergency warning system is responsive to a signal emanating from a direction forwardly of said navigation apparatus, rearwardly of said navigation apparatus, rightwardly of said navigation apparatus, or leftwardly of said navigation apparatus, or from a direction between said rearwardly, frontwardly, rightwardly and leftwardly directions.

13. The navigation apparatus of claim 1, and further comprising a power switch, wherein the power switch is independent of the emergency warning system such that the emergency warning system remains on even when the power switch is turned off.

14. The navigation apparatus of claim 1, and further comprising a power port such that a power source outside of the navigation system may be accessed to power the navigation apparatus.

15. The navigation apparatus of claim 1, and further comprising a computer connection port for connection to a computer such that information can be downloaded into the navigation system.

16. The navigation apparatus of claim 1, wherein the display is a touch screen display.

17. The navigation apparatus of claim 1, wherein the navigation system provides text-to-speech.

18. The navigation apparatus of claim 2, and further comprising a suction cup and a base for the suction cup, wherein the base is connectable to the housing, whereby the navigation apparatus having the receiver can be fixed in a vehicle at a location where said right of way vehicle predefined signal can be picked up and whereby at the same time the display of the navigation apparatus can be seen by a driver of the vehicle.

19. A stand alone navigation apparatus comprising:
a) a navigation system, wherein said navigation system includes a processor, a global positioning system, a touch screen display, a speaker, a power port such that a power source outside of the navigation system may be accessed to power the navigation apparatus, a computer connection port for connection to a computer such that information can be downloaded into the navigation system, and with the navigation system providing text-to-speech;
b) an emergency warning system for picking up a right of way vehicle predefined signal, with the emergency warning system being in communication with said navigation system, with the emergency warning system comprising a first receiver responsive to said right of way vehicle predefined signal, and with the emergency warning system emitting, when said right of way vehicle predefined signal has been picked up by said first receiver, at least one of an audio warning via said speaker and a visible warning via said display;
c) wherein the navigation system further comprises a power switch that is independent of the emergency warning system such that the emergency warning system remains on even when the power switch is turned off;
d) wherein the navigation system and emergency warning system are housed in a housing; and
e) wherein said first receiver is disposed on the housing and is responsive to a right of way predefined signal that includes a set of 14 pulses of light.
